(19) United States
(12) Patent Application Publication
(10) Pub. No.: US 2015/0250157 A1
(43) Pub. Date: Sep. 10, 2015

(54) DEVICE FOR FISHING

(71) Applicant: Juri VABA, (US)

(72) Inventor: Juri Vaba, Goteborg (SE)

(21) Appl. No.: 14/429,266

(22) PCT Filed: Sep. 17, 2013
(86) PCT No.: PCT/SE2013/000141

§ 371 Date: Mar. 18, 2015

(30) Foreign Application Priority Data
Sep. 18, 2012 (SE) 1200565-8

(51) Int. Cl. A01K 91/14; A01K 91/04; A01K 83/06

(52) U.S. Cl. CPC A01K 91/14; A01K 83/06; A01K 91/04

(57) ABSTRACT

Disclosed is a device BS mainly for fishing on and near the bottom without hooks snagging on bottom objects. BS consists mainly of two parts with different densities; a lower part (heavier than water) and an upper part (lighter than water). The whole device is sinking but due to the parts difference in density it holds a position with the sinking part down and the buoyancy part with bait and hooks above making it avoid bottom contact both when stationary and when moving. The device has a design which makes it pass most obstacles which are found on bottom without snagging. Parts of the device can be made of hard or soft material. To reduce disturbing light reflections some surfaces are dull and angled. Artificial baits for BS can be designed differently and they should have less density than water. Natural baits can be used with a floating body.

### FIELD OF INVENTION

The present invention is a device named Bottom Sneaker, here referred to as “BS”, for fishing with line, bait and hook. This may be utilized for example for spin fishing by rod, trailing after boat, and bottom angling, and it can be fitted with artificial lure or with hooks for natural bait.

### BACKGROUND AND PROBLEM

Many fish species often or always stay near the bottom. In order to catch such fish it is desired to position the bait on the bottom or near the bottom. Since ocean and lake bottoms are often quite uneven, it can be difficult to get a moving bait to follow bottom contours. Another problem is that the bottoms are littered by various objects in which baits, hooks and weights can be trapped. When this occurs, the angler fails to catch fish and may even lose equipment of significant value. When dragging conventional fishing lure on the seabed, they lose the enticing movement that they are designed for, and can accumulate grass and anything else, which reduces their appeal for the fish and impair hooking characteristics. When casting out the fishing tackle, and even when it sinks in the water, it happens that the hooks tangle into other tackle parts, in particular if there is a sinker and/or leaders present. It has also been found that when portions of fishing tackle and sinkers provides sharp glare, this can disrupt a fish approaching the bait or scare it away.

### KNOWN PROBLEMS SOLUTIONS

Well-known measures to avoid losing baits is to use thicker lines, smaller or thinner hooks, upturned single hook and protected hooks. These solutions entail drawbacks, such as shorter throw, greater water resistance, less depth and less hooking of fish.

Devices of the type “bottom bouncers” keep the bait at a distance from the bottom only so long as the fishing line is stretched causing lifting action.

“Bottom bouncers” and devices with weights which are dragged on the ground can become entangled in the bottom vegetation. Devices that are designed to slide above the vegetation are not known.

“Bottom bouncers” and devices with weights that drag on the bottom can easily be wedged in tight spaces such as between rocks and branches in a tree. Devices to smoothly pass such obstacles are not known.

When “bottom bouncers” and other devices with sinkers dragged on the bottom and crossing steep/short obstacle such as a standing sheet, a wire or a fishing net, they can jam by the bait hooks, although sinker successfully passes the obstacle. Devices to pass such obstacles are not known.

“Bottom bouncers” and devices with weights that drag on the bottom are usually provided with soft leaders, whereby the hooks may snag in parts of the apparatus or in the fishing line, either in casting out, or when the apparatus sinks. Devices which avoid this problem have not been found among related patent applications.

“Bottom bouncers” and other devices that are fished close to the bottom are dependent on the fishing line directly or indirectly holding bait and hooks above the bottom. Devices with lures such as jigs, spinners and spoons with buoyancy are not known in this regard.

### PRIOR ART SURVEY

We found at our initial evaluation 6 patents/published applications having similarities with BS and have some of the same field of application. However, none of them have the same essential features as the BS nor the construction or use of material. The following two publications show the most similarity with the invention.

| | | |
|---|---|---|
| U.S. Pat. No. 7,866,085 | A01K91/00 | A01K91/06D |
| US2011271581 | A01K95/00 | |

### DETAILED DESCRIPTION

The invention will be described with reference to preferred embodiments, shown in accompanying figures.

The BS device comprises materials having an average density greater than 1.0 gram/cm³. The entire device thus sinks in water. BS consists of two main parts; hereinafter referred buoyancy member and sinking member, both of which can be made of various hardness and flexibility.

The sinking member may be a rigid or a flexible device with average density greater than 1.0 gram/cm³.

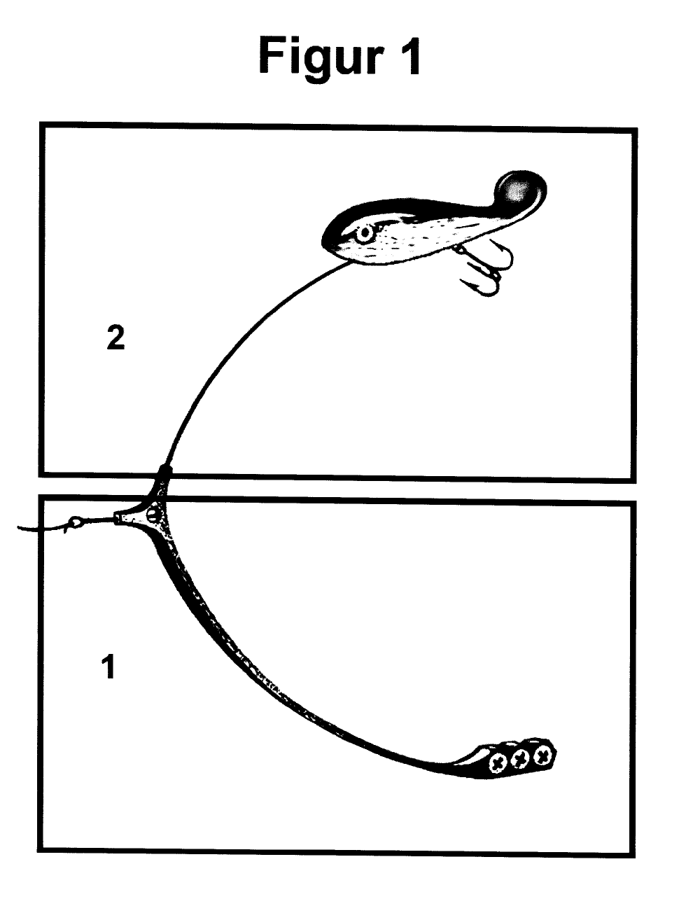

FIG. 1 shows the perspective view of the device with 1) a sinking member of rigid materials comprising of a ski optionally provided with one or more weights and 2) a buoyancy member comprising of a rigid mast and a bait of rigid or flexible material.

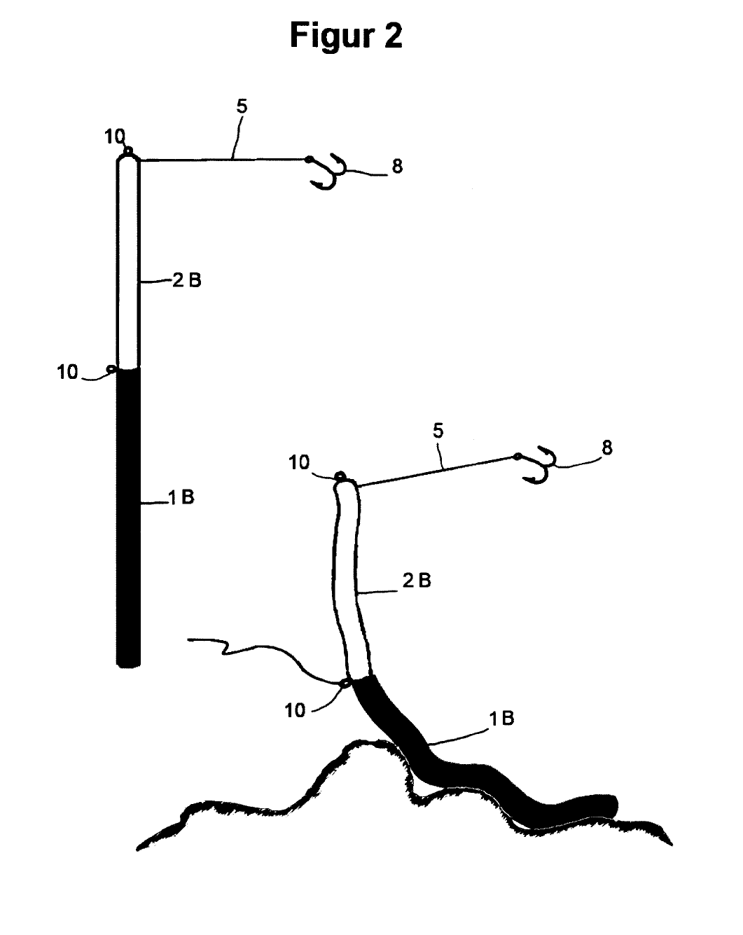

FIG. 2 shows the device of substantially flexible material as an apparatus and on the sea bottom.

1B) A flexible sinking member comprising a cable or a number of links.

2B) A flexible buoyancy member consisting of floating cable or floating links, mast, bait and hook.

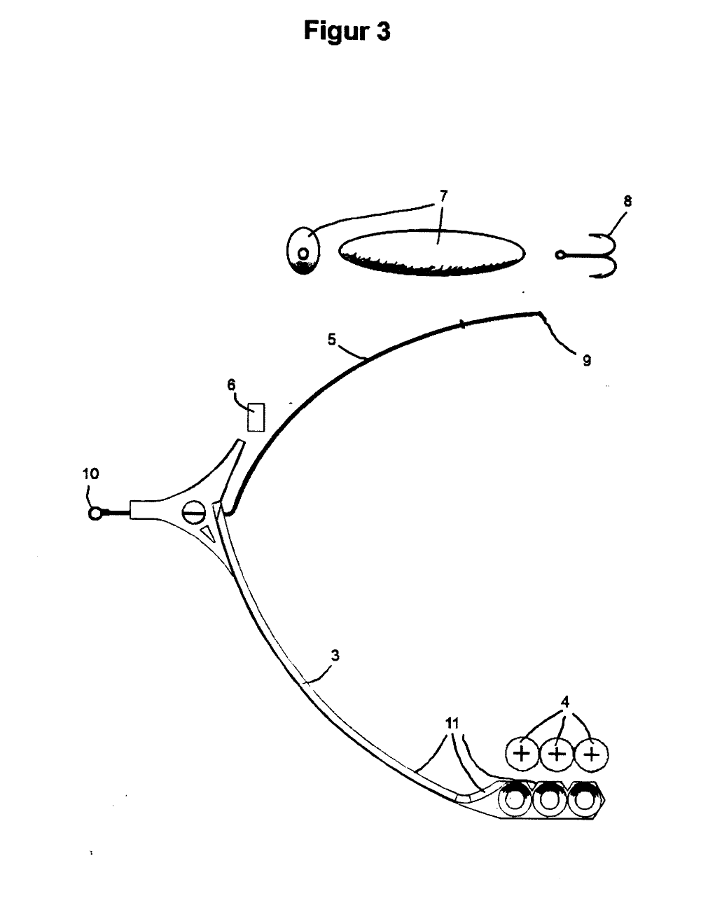

FIG. 3 shows the left side of a rigid device with sinking member (1) which consists of the ski (3), weights (4), and a buoyancy member consisting of mast (5), location tube (6), bait (7), hooks (8), loop to pull line and leader (9), loop to leader and hooks (10), and angled planes of the ski (11).

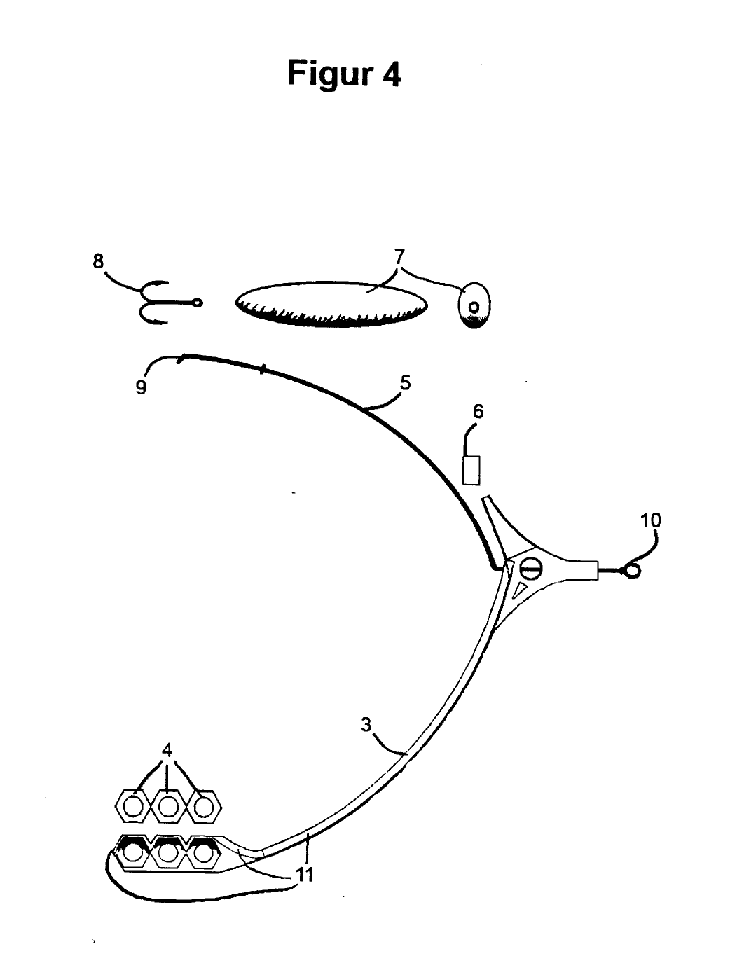

FIG. 4 shows the right side of a rigid device with sinking member (1), which consists of ski (3), weights (4), and a buoyancy member consisting of mast (5), location tube (6) bait (7), hooks (8), loop to leader and hooks (9), loop to pull line and leader (10) and angled planes of the ski (11).

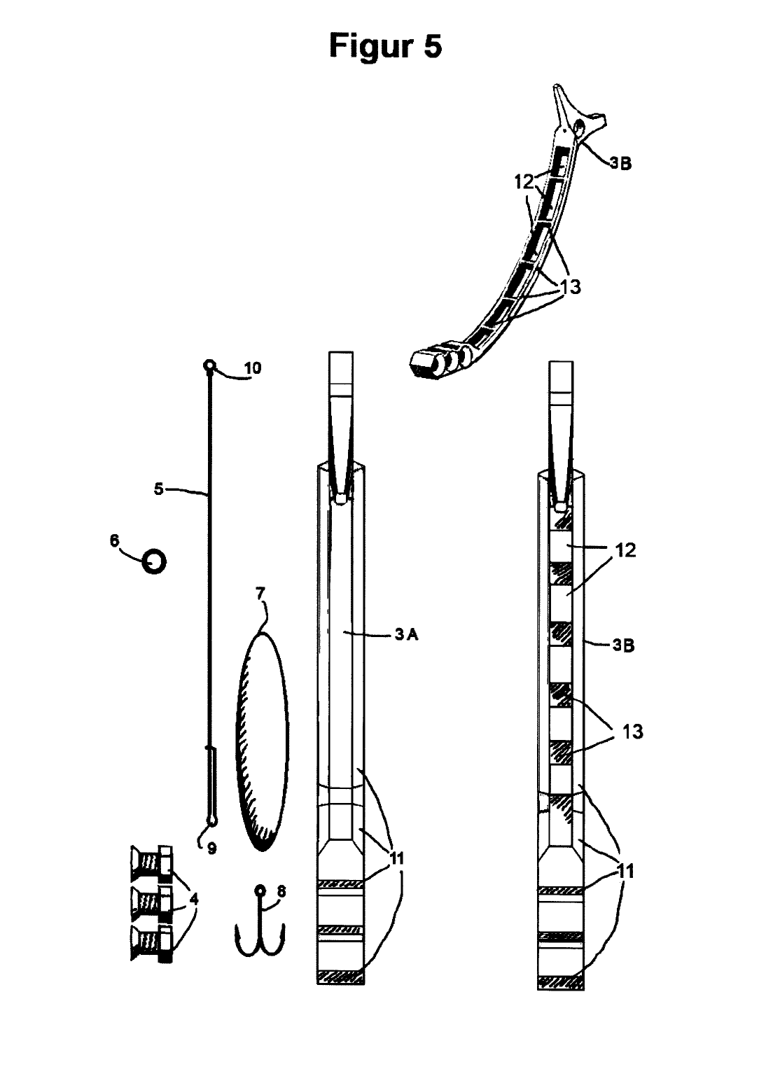

FIG. 5 shows two variations of the ski; (3A) which at forward motion functions as lifting plane, and (3B) with hollowed out area (12) and diving plane (13) which at forward motion works as a diving rudder.

FIG. 6 shows the ski 3 with attachable diving plane 13 and attachable lifting plane 14.

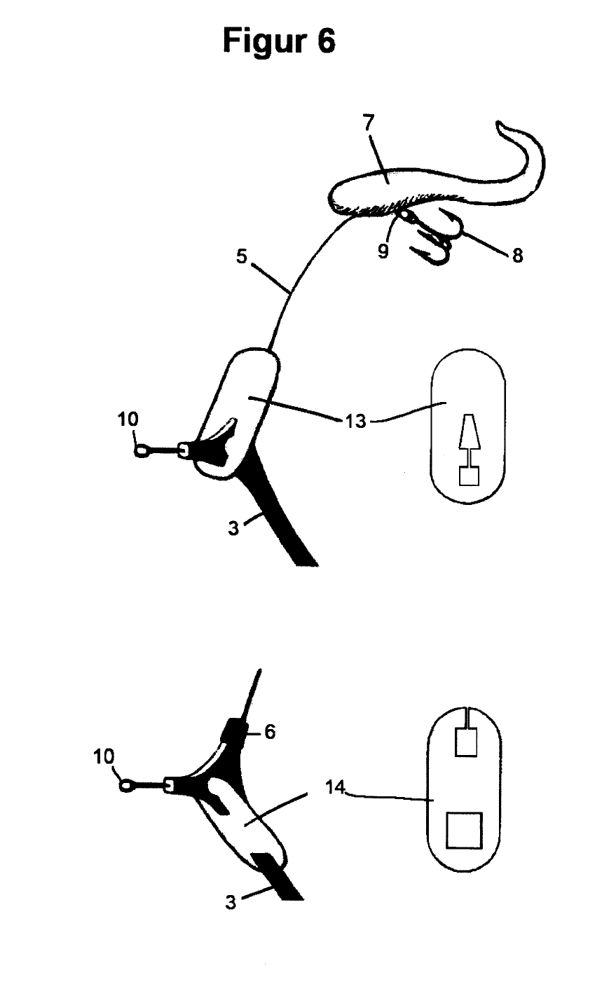

FIG. 7 shows the arrangement of the sliding leader with stop balls 15 at casting and fishing.

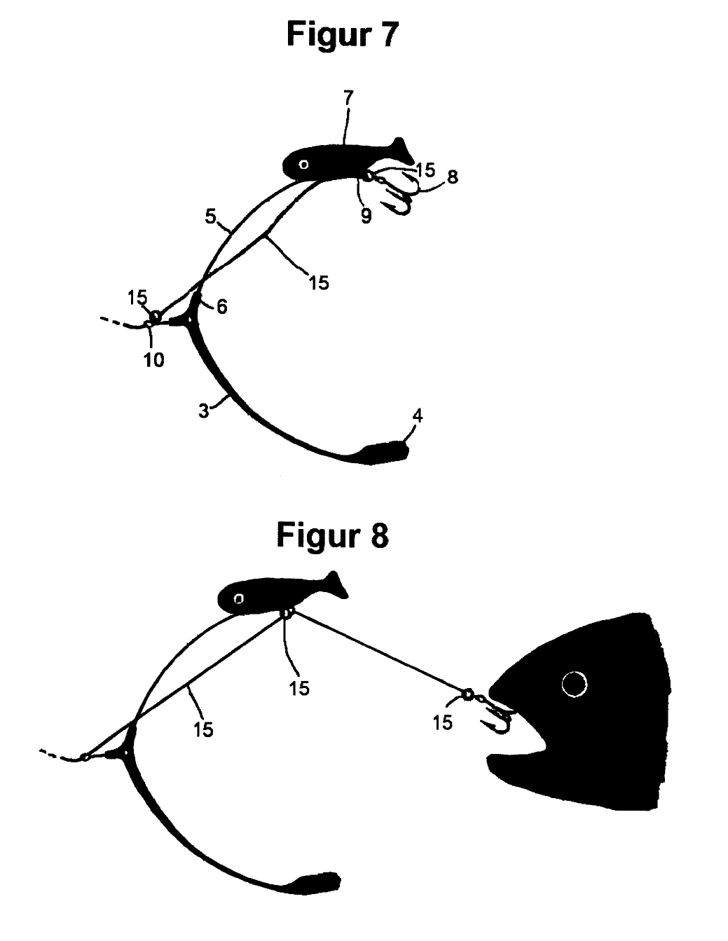

FIG. 8 shows the structure of the sliding leader with stop balls 15 after hooking of fish.

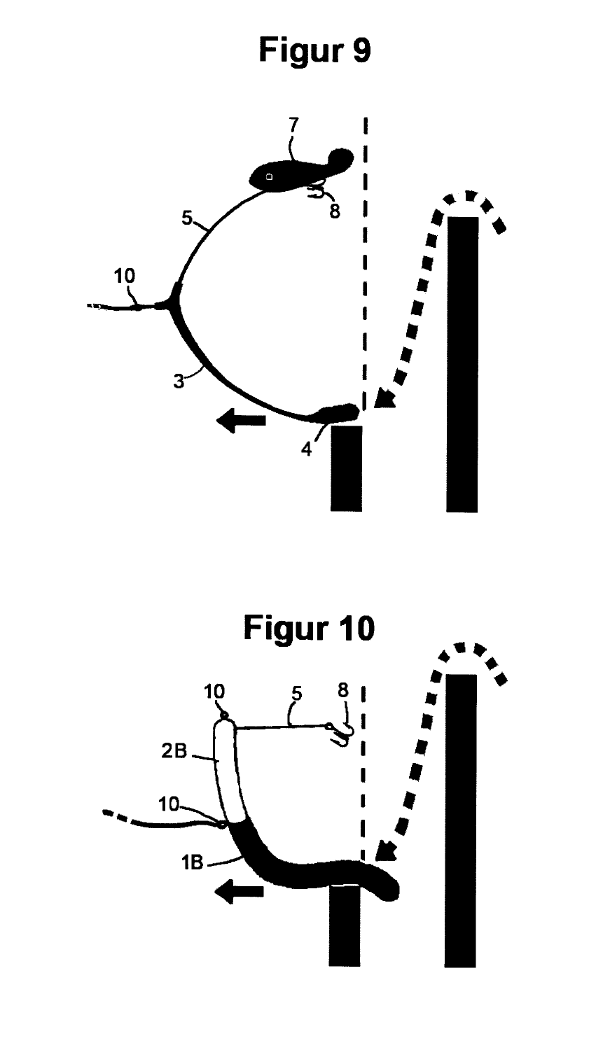

FIG. 9 shows the rigid device when passing sharp obstacles, where bait (7) and hooks (8) pass ahead of the end of the sinking member (1).

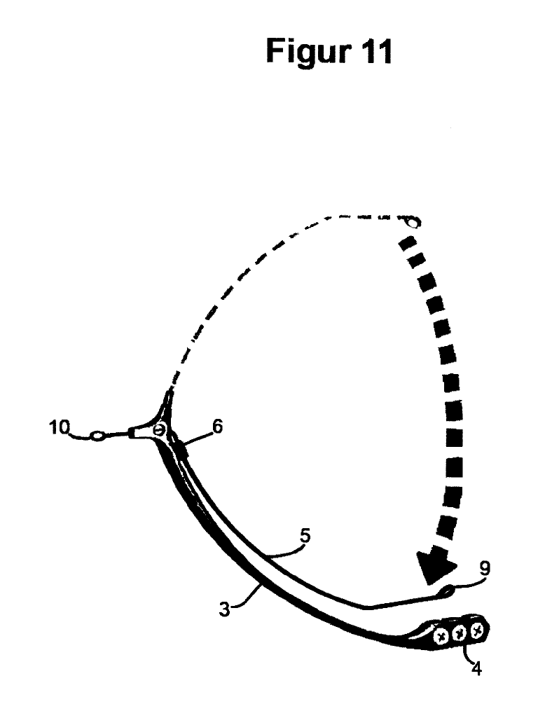

FIG. 10 shows the flexible device when passing of sharp obstacles, where bait (7) and hooks (8) pass ahead of the end of the sinking member (1B).

FIG. 11 shows the sinking member of the rigid structure (1) and the buoyancy member (2) folded together.

### FUNCTION

BS is intended both for stationary and moving fishing with continuous or intermittent bottom contact. The device has one or more loops for connection to a pull line. The loops are positioned so that the pull line is normally connected to the apparatus at a distance above the bottom. By appropriately balanced relationship of density and volumes in sinking member and buoyancy member, the device will sink in water until the sinking member reaches the bottom and then assume a position with buoyancy member and the bait above the sinking member so that bait and hooks avoid bottom contact. At either stationary location or at motion, the bait and hooks keep a certain minimum distance from the bottom. The bait can be artificially made of buoyant materials, or natural bait carried by a floating body. The sinking member and the buoyancy member with bait and hooks are adapted in length so that during forward motion and after passing the obstacle, the buoyancy member portion with bait and hook always passes the obstacle ahead of the rearmost portion of the sinking member.

Below the attachment loop for the pull line, the device is uniformly wide or tapered by reduced width towards the trailing end, so that it crosses barriers of narrow passages without wedging.

The sinking member rigid ski may have a hydrodynamic shape such at fast forward motion by horizontal pull, a vertical force from the water is generated that causes the entire device to rise up, or a different shape such that the forward motion instead pushes the device downwards. Rudder effects can be further enhanced with mountable diving/lifting planes. This provides opportunities for a variety of fishing methods.

### PROBLEM SOLUTIONS

The objective of the present invention is to provide solutions to certain line fishing problems, which is achieved with a device according to the invention, offering the following benefits:

When fishing, you often want to get the bait to sneak near the bottom, even on hilly bottoms. The BS allows controlled and continuous tracking even at a bottom surface large topography.

If it is desired to move a sinking bait very slowly or letting it stop altogether, there is an increased risk of bait and hooks attaching to bottom objects. The BS can do stops without touching the bottom with hooks.

When fishing in areas where there are various obstacles, chances are that sinkers, lures and hooks get stuck, you lose some of their equipment, pollute the bottom and create risks for swimmers. BS passes most obstacles without getting stuck.

Baits dragged on the bottom often lose the motion which attracts the fish to bite and also blocks the hooks completely or partially. The BS has constantly the bait free to move and exposed hooks.

For the BS device, it is appropriate that the bait has static and possibly also dynamic lifting force. “Wobbler” and “Popper” are bait types with buoyant models and with static lift.

However, these are not known to include a lifting plane providing dynamic lift at motion. Bait types as jigs, spoons and spinners are not known to include either static lift or lift planes.

Known devices for bottom fishing has usually ball-shaped or oval-shaped sinkers that easily wedge in tight spaces such as between boulders and branches in a tree. BS will pass such obstacles without getting stuck.

Most devices for bottom fishing have a design in which the weights and the whole device or part of it sinks down through vegetation such as seaweed. This means that the bait and hooks are often caught in the plants. BS slides up and over dense bottom vegetation without the hooks catching in other than possibly upper plant parts that are usually soft and easy to rip off.

Known devices for bottom fishing are constructed with leaders of varying length, which means that the hooks often snag into the fishing line or other parts of the structure at throwing or when the apparatus sinks in the water. The BS construction with a rigid mast reduces the risk of such snags.

Known devices for bottom fishing that consists of leaders and sinkers are designed so that when the device is pulled slowly or completely at a stop, the bait and hooks drop to the bottom and can be caught. BS hooks are always above bottom.

Known devices for bottom fishing are so constructed that when crossing a branch, a wire, a net or the like, even without sinker getting stuck, the bait hooks may still get stuck in the object on the bottom that the sinker weight just passed. BS design allows it to pass such obstacles without getting stuck.

Stairstep fishing is a combined vertical and horizontal motion technique which with other fishing devices assumes that you are high above the bait and by pulling on the line generates a substantial vertical force component. BS has a design with lifting plane so that stairstep fishing can be applied by fully horizontal thrust as when the pull cord is long in relation to depth.

Drift fishing behind a boat and trolling is usually done with the bait in free water space and using heavy sinkers to keep the fast moving bait at a moderate depth. If you then pass a shipwreck or other protruding objects, the sinker and bait may be caught and immediately dislodged. These risks are substantially reduced with BS.

When fishing at greater depths and flowing water, it is difficult to keep most moving baits near the bottom. BS may have a shape with fixed and mountable diving plane that with forward motion will provide a dynamic downward force.

Other parts than the bait can catch the fish's attention or scare it by sharp light reflections of i.e., sinkers and leaders. To reduce unwanted glare is BS mainly made of transparent or dark material with a rough, matte finish and appropriately angled planes in the surfaces, known as stealth design.

1. A device for line fishing, comprising two main parts, a sinking member (1) as a curved ski, (1B) a cable, chain or a beaded lace and a buoyancy member (2), (2B), wherein the sinking member with an average density greater than water is disposed below the attachment for a pull line (9) and that the buoyancy member (2), (2B) with average density less than water is arranged above the attachment for the pull line (9) and so arranged that the buoyancy member lift force in water is directly vertically above the sinking member center of gravity and that the whole apparatus apparent density is greater than water, causing the buoyancy member comprising bait (7) and hooks (8) by its density distribution be in a position constantly vertically above the sinking member, for both when the sinking member is stationary resting on the bottom, or when the device is in motion either by freely sinking towards the bottom or by pulling on the pull line.

2. Device according to claim 1, wherein the sinking member (1), (1B) has a constant width or is tapered narrower towards its lower rear end, so that it avoids to become wedged in narrow passages in the bottom structure and a sunken object, at forward motion.

3. Device according to claim 1, wherein the length ratios of the sinking member (1), (1B) and buoyancy member (2), (2B), are such that when moving forward with the help of the pull line, the bait (7) and the hooks (8) when passing a bottom barrier or in the water submerged obstacles, will pass ahead of the sinking member rearmost part passing the same obstacles, so the risk of bait (7) and hooks (8) to become trapped in the barrier is substantially reduced.

4. Device according to claim 1, wherein by means of a mast (5), the bait (7) and the hooks (8) are spaced from the other parts and from the pull line, which considerably reduces the risk that the hook becomes entangled into other parts or the pull line.

5. Device according to claim 1, wherein both the sinking member (1) and the buoyancy member (2) are of rigid construction.

6. The apparatus of claim 1, wherein both the sinking member (1B) and the buoyancy member (2B) are of flexible construction.

7. Device according to claim 1, wherein the sinking member (1), (1B) is made of transparent or dark material with rough, dull surface and suitably broken into angled surface planes (11) so that light reflections are reduced.

8. Device according to claim 1, wherein the artificial baits (7) in the form of jigs, spinners and spoons, have an average density lower than 1.0 gram/cm³, in that they are made of buoyant material, have built in incompressible chamber with gas and/or pores and/or embedding micro balloons in the material and that the baits have a hole through to rotate or wiggle on an axis which comprises the mast (5) of the device.

9. Device according to claim 1, wherein the bait (7) in different shapes have a type of lift plane that at forward motion provide dynamic lifting force.

10. Device according to claim 1, wherein one or more loops (9) (10) are positioned so that a sliding leader with one or more stop balls (15) can connect the pull line with bait hooks (8) such that the hooks do not catch on elsewhere, on casting or sinking.

11. Device according to claim 1, wherein the rigid sinking member (1) has one or more attachments for weights (4) which can be fitted or removed and thus changes the device's weight and balance, or a flexible sinking member (1B) consisting of a cable or links may be lengthened or shortened to vary the weight.

12. Device according to claim 1, wherein the sinking member ski (3) is designed as a fixed lifting plane, or the ski (3B) is provided with holes and fixed diving plane (13) and/or mountable diving plane (14) and/or mountable lifting plane (15) so that forward movement produces a downward dynamic force or an upward dynamic force that controls the device in the desired direction.

13. Device according to claim 1, wherein the device can be folded by rotation about the mast (5) in the ski (3) (3B), or sinking member (1B) and buoyance member (2B) can be folded together for transport requiring less space.

14. Device according to claim 2, wherein the length ratios of the sinking member (1), (1B) and buoyancy member (2), (2B), are such that when moving forward with the help of the pull line, the bait (7) and the hooks (8) when passing a bottom barrier or in the water submerged obstacles, will pass ahead of the sinking member rearmost part passing the same obstacles, so the risk of bait (7) and hooks (8) to become trapped in the barrier is substantially reduced.

15. Device according to claim 2, wherein by means of a mast (5), the bait (7) and the hooks (8) are spaced from the other parts and from the pull line, which considerably reduces the risk that the hook becomes entangled into other parts or the pull line.

16. Device according to claim 3, wherein by means of a mast (5), the bait (7) and the hooks (8) are spaced from the other parts and from the pull line, which considerably reduces the risk that the hook becomes entangled into other parts or the pull line.

17. Device according to claim 2, wherein both the sinking member (1) and the buoyancy member (2) are of rigid construction.

18. Device according to claim 3, wherein both the sinking member (1) and the buoyancy member (2) are of rigid construction.

19. Device according to claim 4, wherein both the sinking member (1) and the buoyancy member (2) are of rigid construction.

20. The apparatus of claim 2, wherein both the sinking member (1B) and the buoyancy member (2B) are of flexible construction.
